(19) United States
(12) Patent Application Publication
(10) Pub. No.: US 2007/0041549 A1
(43) Pub. Date: Feb. 22, 2007

(54) Card armor

(76) Inventor: Joel Goslar, Baltimore, MD (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/207,191

(22) Filed: Aug. 18, 2005

(51) Int. Cl. H04M 3/42

(52) U.S. Cl. 379/208.01

(57) ABSTRACT

A method and system for screening telephone calls includes a system including a call handler; a processor, in communication with the call handler; and a memory unit, in communication with the processor. The method includes receiving an incoming call; setting an integer value to 1; playing a prerecorded voice message; playing a prerecorded noise packet; increasing the integer value by 1; and checking the integer value and replaying the prerecorded voice message, replaying the prerecorded noise packet, and increasing the integer value by 1 if the integer value is less than 3, and allowing a caller to leave a message if the integer value is greater than or equal to 3.

### CROSS REFERENCED TO RELATED APPLICATIONS

This application claims the benefit of U.S. Provisional Patent Application Ser. No. 60/2336, filed on Aug. 18, 2004, which is incorporated herein in its entirety. [Filing Confirmation: docket #1050.01 (provisional application) was filed on Aug. 18, 2004]

### FIELD OF THE INVENTION

The present invention relates to a method and system for screening telephone calls and in particular to a method and system for screening unwanted and unwelcome telephone calls.

### BACKGROUND OF THE INVENTION

There are few annoyances worse than having a telemarketer call during dinner. Just as a family is sitting down for dinner, it seems that the phone will invariably ring, and an obnoxious telemarketer will be on the other end of the line. Answering the phone and politely asking the telemarketer to leave you alone rarely works, as they continue to talk and try to get you to purchase whatever goods or services they are peddling. Letting the call go to the answering machine often just invites the telemarketer to call back the next night at dinner.

U.S. Pat. No. 6,519,335 is directed towards an apparatus, method and system for personal telecommunication incoming call screening and alerting for call waiting applications. During a first telecommunication call, the method includes, first, receiving a second telecommunication call, and second, determining a relative priority of the second telecommunication call compared to the first telecommunication call. When the second telecommunication call has a same relative priority or a higher relative priority than the first telecommunication call, the method provides a first level of priority service to the second telecommunication call, such as interrupting the user and providing a distinctive user alert during the first telecommunication call indicative of the same or higher level of priority. When the second telecommunication call has a lower relative priority than the first telecommunication call, the method provides a second level of priority service to the second telecommunication call, such as providing a distinctive user alert indicative of a lower relative priority, and providing automatic messaging or voice mail service to the second telecommunication call. The various embodiments determine these relative priorities based upon user input or based upon the observed, actual behavior of the user or subscriber, such as whether the user allows certain current calls to be interrupted by other incoming calls, whether the consumer accepts and continues with an incoming call while releasing the current call, or whether the consumer returns to the current call from call waiting while releasing the incoming call.

U.S. Pat. No. 4,634,811 is directed towards a call screening system to be added onto and used with a PBX or Centrex telephone system having an attendant answering console. The call screening system enables incoming calls for various telephone extensions to be directed to another telephone extension in the system for screening such incoming calls. The call screening system includes a DTMF tone generator and a screening system. The DTMF tone generator is coupled to the attendant answering console for generating a first DTMF coded signal for enabling the attendant answering console to call a screening telephone extension within the telephone system and generating a second DTMF coded signal that provides an indication as to the particular telephone extension within the telephone system for the person that the incoming caller is calling. The screening system is coupled between a single tip/ring line from the PBX or Centrex and a tip/ring line to a screening telephone extension of a user screening incoming calls for other telephone extensions. The screening system receives a call from the attendant answering console when the associated screening telephone extension has been called by a generated first DTMF coded signal for such screening telephone extension, receives a generated second DTMF coded signal generated by said DTMF tone generator for indicating which of the telephone extensions being screened the call is for and generates an indication signal indicating which telephone extension the call is for. After receiving such second DTMF coded signal, the screening system couples the screening telephone extension to the tip/ring line from the PBX or Centrex system for establishing a voice path connection.

U.S. Pat. No. 6,647,106 is directed towards an advanced intelligent network privacy screening service that allows callers provided with a bypass code to bypass the privacy screening. A termination attempt trigger is provisioned on the subscriber's line at a service switching point. When callers from private or unknown numbers call the subscriber, the call is routed to a service node that plays an announcement to the caller to start the privacy screening process. The caller can then enter the bypass code to bypass the privacy screening. A subscriber to the privacy screening service can change his or her bypass code by calling a system administration number, and entering his or her password and bypass code.

U.S. Pat. No. 4,805,209 is directed towards data about a client created and entered on an agent's data terminal during a teleconference with the client. Often, it is necessary to transfer the client to a specialist during the course of the conversation. This invention describes a method of transferring the call and the data terminal information associated with the call to any available phone extension with an associated data terminal. A Computerized Branch Exchange (CBX) is used to transfer the call and pass a host program the phone source extension and the destination extension for the transfer. The host program looks up the source and destination extensions in a phone to terminal file and determines the network address of the data terminals involved and transfers the appropriate host application terminal display to invoke a transfer of display information. The host application sends the data terminal information to the destination data terminal display in conjunction with the transferred phone call.

U.S. Pat. No. 4,277,649 is directed towards a telephone system for providing customized telephone services. A called customer can screen calls incoming to his station based on the identity of the calling line. The calling line's identity is forwarded to the switching office containing the called customer's screening memory. The memory is interrogated to ascertain the call disposition based on information priorly put in the memory by the called customer. Selective call waiting, selective call forwarding, priority ringing, and many other customized services are contemplated.

U.S. Pat. No. 5,467,388 is directed towards a system for allowing a telephone subscriber to selectively block incoming calls for selected time periods or during programmed time intervals. A subscriber may pre-program a time interval in minutes, or a time period (start time and end time) for which some or all incoming calls are to be blocked. The subscriber may assign caller numbers or personal identification numbers to one of a plurality of tiers of access. The subscriber may enable the call blocking system for selected access tiers. An emergency access tier may be provided to insure emergency calls are not blocked by the system.

U.S. Pat. No. 6,606,505 is directed towards a method and system for providing a novel wireless centrex service that untethers subscribers from the immobility associated with traditional desktop telephones. Essentially, the present invention extends the benefits of wireless voice and data services to subscribers having a need to move within a plurality of localities such as business and hospital campuses. In accordance with the invention, a wireless telephone subscriber can use a standard cellular/PCS telephone as a wireless extension of their desktop phone, while in the proximity of a miniature radio base station capable of communicating with the PCS/cellular telephone. The advantage of such a system is that a subscriber can use the same cellular/PCS telephone that provides service in the public network in the wireless centrex environment. Additionally, the wireless centrex system provides services and features which are similar to those offered to regular centrex telephone subscribers. Exemplary features include, caller ID, call waiting, call hold, call transfer, call forwarding and voice messaging.

U.S. Pat. No. 5,850,435 is directed towards a method to audibly announce an identified caller name includes one embodiment, the caller name includes determined by making a query to a database with phone numbers and corresponding line owners (e.g., to the line information database (LIDB)). In this embodiment, the system phonetically pronounces the name found in the database to the subscriber in an announcement. In another embodiment, the system requests that the calling party speak their name. The spoken name is recorded, and played back to the subscriber in an announcement. The caller is placed on hold while the caller name is provided to the subscriber in an announcement. The subscriber may either accept the call, or reject the call. If the call is accepted, the call is connected. If the call is rejected, the line is busy, or there is no answer, the caller is notified. In one embodiment, a rejected call is transferred to a voice mail system. In yet another embodiment, the subscriber can selectively activate or deactivate the audible caller name feature (e.g., in order to take calls personally without screening, or to use an answering machine). In yet another embodiment, incoming call names are placed on a call list. The subscriber can later access the call name list, and make calls to telephone numbers corresponding to names on the list.

U.S. Patent Application No. 20040258220 is directed towards systems and methods for monitoring and intercepting messages to a voicemail system connected to an AIN or WIN network for screening calls incoming to a landline or wireless telephone. After a call is forwarded to voicemail system, the called party is provided an opportunity to monitor a message as it is spoken into a voicemail system. The called party may intercept the message at any time during delivery of the message to answer the telephone call.

U.S. Patent Application No. 20040213396 is directed towards reducing occurrences of nuisance calls. A called party identifies a call as an undesired (or “nuisance”) call after answering, screening or reviewing recorded messages of calls. In one embodiment, the called party receives or screens a call and informs a terminating office that it desires to block future calls from the calling party. The terminating office determines the directory number of the calling party and causes the directory number to be added to a blocking database. In another embodiment, a called party reviews one or more prior messages recorded by a messaging system (e.g., answering machine or voicemail system) and flags a message (e.g., message #2) as originating from an undesired caller. The messaging system determines the directory number of the undesired caller and instructs a service provider to add the directory number to a blocking database. Thereafter, in either or both embodiments, the blocking database is consulted upon receiving an incoming call and, if the call is from a directory number in the blocking database, the call is ended or routed to an announcement without ringing the called party phone.

U.S. Patent Application No. 20040174975 is directed towards a service node capable of coordinating call processing for incoming calls intended for any one of multiple telephony devices of a given entity, such as a business or individual user. Switching devices, such as traditional telephony switches or internetworked gateways controlling call routing, are configured to interact with a service node to determine how to handle incoming calls to the telephony devices that they serve. As such, call processing rules, which are established by the entity, are applied to an incoming call to any of the entity's telephony devices to effectively route calls to other ones of the telephone devices, route the call to a desired voicemail system, provide call screening or blocking, and any other desired call control activity. Based on the call processing rules for the given entity, the service node will instruct the corresponding telephony switches to handle the incoming call.

None of the above devices, however, provide a method and system for screening telephone calls that warns the caller the receiver does not want to be bothered with unwelcome calls, and produces a sound or tone to persuade the unwelcome caller to hang up. It would therefore be beneficial if such a device were provided.

Telemarketers now place 148 million junk calls a day according to Private Citizens, Inc and 92% of adults have reported receiving fraudulent telephone offers. One out of every ten telemarketer's calls is fraudulent and telemarketing criminals cheat an estimated one out of six consumers every year.

The Department of Justice says Telemarketing fraud or “phone fraud” is the most frequent and most expensive complaint. Why is our invention so beneficial? Because so many telephone customers fall prey to the unwanted telemarketer trap. Some people are used to receiving unsolicited calls from salespersons and telemarketers. They do not find cold calling to be unusual. Some people do not want to be rude and hang up. The Boiler room operators know how to keep you listening. The victim maybe suspicious but cannot resist them. The representatives sound professional. Some are attracted to the once in a lifetime offer or hyped high returns on stocks. Greed!

Unwanted Telemarketer con artists not only rob victims of their money but also of their human dignity. Many telephone customers end up losing so much money, broke and helpless and continuously getting called again and again. The victims are then contacted by other unwanted telemarketers who claim they can recover all the money for a few thousand dollars in fees. In their desire to make up lost financial ground all too often the result is those unwary telephone customers particularly senior citizens lose whatever savings they have left in the wake of the initial telemarketer scam. Yet these unwanted fraudulent telemarketers are often difficult to catch. They often work in boiler room leased spaces with banks of phones staffed by fraudsters. Once under investigation, they can shut down easily change their company name, and move to another town or state or country. In many cases, unwanted telemarketer crooks are sitting just far, enough away from U.S. laws and jurisdiction to reduce the chances that American victims will ever recover their money. Our invention fully recognizes the major problems of unwanted and fraudulent telemarketer calls, is unique and very necessary and stops this victimization of telephone customers without risk.

### SUMMARY OF THE INVENTION

It is an aspect of the present invention to provide a novel system for screening telephone calls from unwanted telemarketers [and telemarketing criminals.] [Consumers are becoming more concerned about unwanted telemarketing calls, and not only because they worry about their privacy: increasingly, consumers are not only annoyed, but also taken advantage of, by telemarketers out to defraud them.

To respond to consumers' concerns about privacy, the telecommunications industry introduced Caller ID. But where telemarketer fraud is concerned, Caller ID has limitations that leave a market unprotected against fraud. It merely adds a screen between the caller and the consumer; it does not deter unwanted telemarketers and fraudulent calls. To detect fraudulent calls, consumers must listen to the caller and make judgments, a difficult process, especially for older consumers raised in an era when trust was a norm. Consumers do not want to do this work. The best solution to unwanted telemarketer calls and telemarketer fraud is prevention: a clear signal to unwanted telemarketers that there is no point in trying to get through. Our Method and system for screening telephone calls is the real solution to unwanted telemarketers and telemarketer fraud because: according to the U.S. Department of Justice the best protection is prevention. Our invention provides this prevention. Our invention also distinctively deters unwanted telemarketer calls and allows telephone customers to protect themselves and loved ones against telemarketing fraud.

Our Method and system for screening phone calls achieves all of this for the telephone customers without any risk. Our invention ensures that the customer will never be harmed by unwanted telemarketer calls and telemarketer fraud ever again. In our invention the unwanted telemarketers and telemarketer fraudsters can never succeed and because they cannot win they stop calling the customer. Moreover our invention is designed to work effectively on any phone against all unwanted telemarketers and telemarketing criminals.

Telemarketer fraud costs consumers $40-$60 Billion a year, according to the FBI and because our method and system for screening telephone calls is the universal solution to all unwanted telemarketers, both legitimate and fraudulent, the estimates should include unwanted legitimate telemarketing, which is annoying and totaled $440 Billion a year in the USA. Our invention benefits all phone owners. Particularly seniors the fastest growing segment in the U.S. that is relentlessly targeted by telemarketers.

It is a further aspect of the present invention to provide a novel method for screening telephone calls from unwanted telemarketers. With the asset-rich bubble of baby boomers heading into their golden years, advocates are preparing for what could be the perfect setup for elder [telemarketer] fraud on a massive scale. The AARP concluded that simple awareness of the problem was not enough. Many of these aging boomers have money. Currently people over 55 control 70 percent of the nation's wealth. In a few years circa 2008 there will be a great influx of new retirees about 76 million and they will be getting lots of telemarketer calls. They will be obvious targets for unwanted corrupt telemarketers, lottery scammers and more. As a result, there will soon be an even greater need for our invention. And anyone can fall prey to an unwanted telemarketer con artist-law enforcement files are filled of cases in which well educated individuals were duped by phony callers. Our method and system for screening telephone calls, is the first real solution to unwanted telemarketers and telemarketer fraud, and will single-handily attract and help millions of these people protecting them from this problem both now and in the very near future.] Because our invention can work through existing channels, telephone customers easily regain control of their telephones. (Our invention can also enhance Caller ID's usefulness).

It is yet a further aspect of the present invention to provide a novel method for screening telephone calls from unwanted telemarketers that checks an integer value and plays a prerecorded message and noise packet or allows a caller to leave a message based on the integer value.

In accordance with a first aspect of the present invention, a novel system for screening telephone calls is provided. The novel system includes a call handler; a processor, in communication with the call handler; and a memory unit, in communication with the processor.

In accordance with a further aspect of the present invention, a novel method for screening telephone calls is provided. The novel method includes the steps of playing a first message to a caller; playing a noise to the caller; and playing a second message to the caller.

In accordance with yet a further aspect of the present invention, a novel method for screening telephone calls from unwanted telemarketers that checks an integer value and plays a prerecorded message and noise packet or allows a caller to leave a message based on the integer value is provided. The novel method includes the steps of receiving an incoming call; setting an integer value to 1; playing a prerecorded voice message; playing a prerecorded noise packet; increasing the integer value by 1; and checking the integer value and replaying the prerecorded voice message, replaying the prerecorded noise packet, and increasing the integer value by 1 if the integer value is less than 3, and allowing a caller to leave a message if the integer value is greater than or equal to 3.

### BRIEF DESCRIPTION OF THE DRAWINGS

The foregoing summary, as well as the following detailed description of a preferred embodiment of the present invention will be better understood when read with reference to the appended drawings, wherein:

FIG. 1 is a flow chart depicting an embodiment of a method for screening telephone calls in accordance with the present invention.

FIG. 2 is a flow chart of an alternative embodiment of a method for screening telephone calls in accordance with the present invention.

FIG. 3 is a block diagram of a system for screening telephone calls in accordance with the present invention.

### DETAILED DESCRIPTION OF THE PREFERRED EMBODIMENT

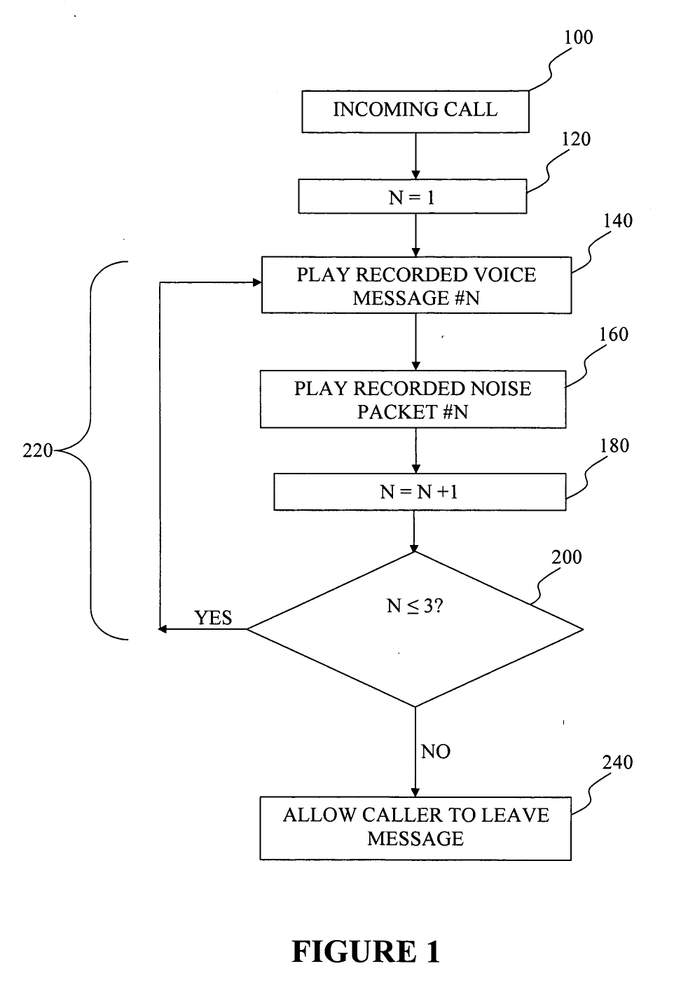

Referring now to the drawings, wherein like reference numerals refer to the same components across the several views and in particular to FIGS. 1-3, a method and system for screening telephone calls is depicted.

FIG. 1 shows a flow chart of an embodiment of the invention. A call is received at 100 and an integer variable “N” is set to equal numeric value 1 at 120. A prerecorded voice message (identified in FIG. 1 as voice message #N) is played at 140; since N=1, the prerecorded voice message is #1. Upon termination of the prerecorded voice message #1, a noise packet (identified in FIG. 1 as noise packet #N) is played at 160. Upon termination of the noise packet #1 the integer value of N is checked at 200. If N is less than or equal to 3, then loop 220 is repeated until N has an integer value greater than 3. Since N was set to an initial integer value of 1 and N is increased in value inside the loop 220, the loop will repeat just once since on the next iteration N will have an integer value of 3 and the loop will terminate at 200 and the caller is allowed to leave a message at 240.

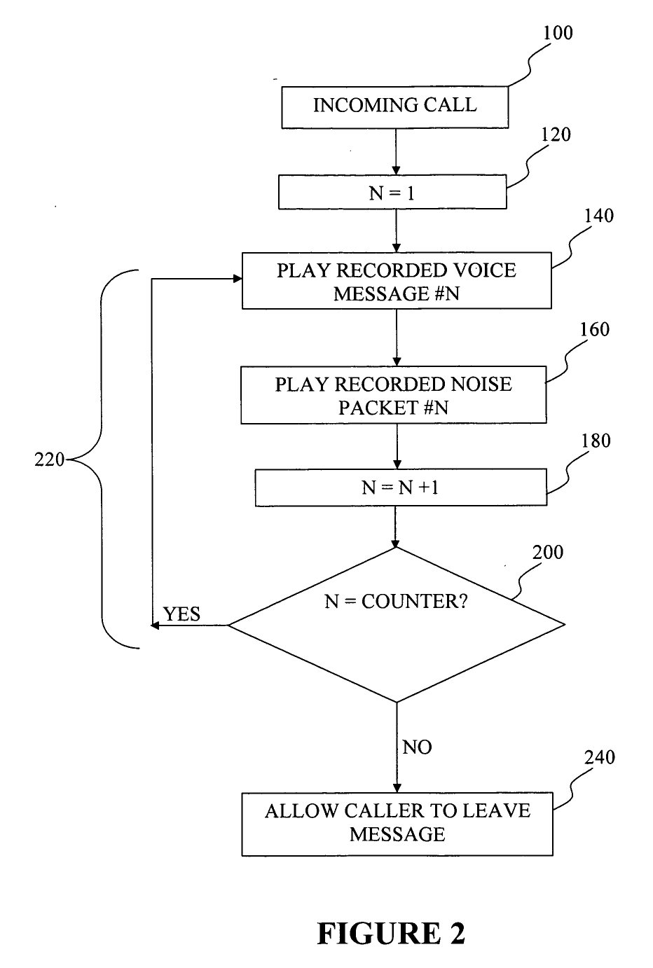

FIG. 2 shows a flow chart that is similar to that shown in FIG. 1, except that at 200 the numeric value of N is checked against a predetermined constant numeric value “COUNTER”. Hence, loop 220 will repeat until N equals COUNTER. Since N is an integer value, COUNTER must also be an integer value otherwise loop 220 will be repeated indefinitely. For example, if COUNTER is equal to integer value five (numeric 5), then loop 220 will repeat until N equals integer value 5; hence five separate voice messages will play along with five separate noise packets.

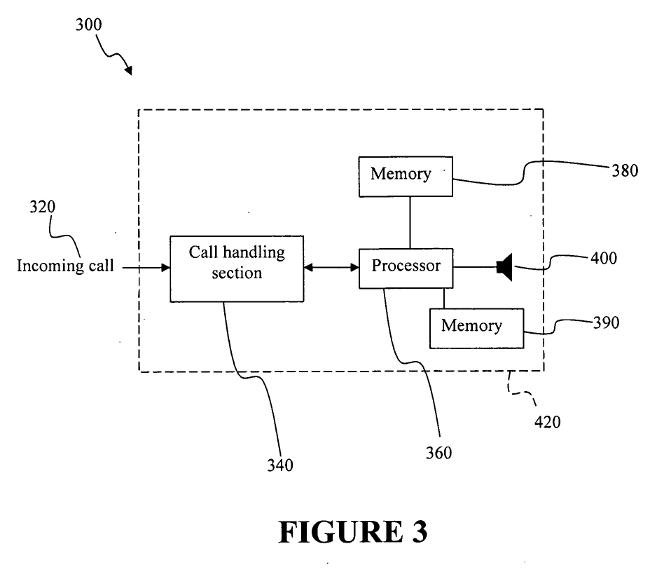

FIG. 3 is a block diagram of an apparatus 300 for handing an incoming call 320. An incoming call 320 is handled by a call handling section 340, which is in operable communication with processor 360. The processor 360 is in operable communication with memory 380 such that the processor 360 can perform the logic steps necessary to handle incoming calls (see, e.g., flows charts shown in FIGS. 1 and 2), particularly calls from telemarketers. It should be understood that any component part of the apparatus 300 could be integrated; e.g., the memory 380 and/or call handling section 340 can be integrated with the processor 360 and embedded on a single integrated chip. Verbal messages and noise packets are stored in memory 380; memory 380 is preferably read only memory to avoid loosing verbal messages and/or noise packets in the event of a power failure. Messages left by callers are stored in erasable memory 390; memory 390 may be integrated with processor 360. The operator of apparatus 300, such as a senior person easily taken in by scam artists or fraudulent telemarketers, can listen to stored messages via speaker 400. The components parts 340, 360, 380, 390 and 400 are housed in housing 420.

In view of the foregoing disclosure, some advantages of the present invention can be seen. For example, a novel method and system for screening telephones is disclosed. The novel method and system provides for a user to screen unwelcome calls, while inviting a welcome caller the opportunity to leave a message.

While the preferred embodiment of the present invention has been described and illustrated, modifications may be made by one of ordinary skill in the art without departing from the scope and spirit of the invention as defined in the appended claims.

What is claimed is:

1. A system for screening telephone calls, comprising:
a call handler;
a processor, in communication with the call handler; and
a memory unit, in communication with the processor.

2. The system of claim 1, wherein verbal messages and noise packets are stored in the memory.

3. The system of claim 1, wherein the memory is read only memory.

4. The system of claim 1, wherein the memory, call handler, and processor are integrated into a single chip.

5. A method for screening telephone calls utilizing a system for screening telephone calls that includes a call handler, a processor, in communication with the call handler, and a memory unit, in communication with the processor, comprising the steps of:
playing a first message to a caller;
playing a noise OR TONE to the caller; and
playing a second message to the caller.

6. The method of claim 5, wherein the step of playing a first message to a caller comprises playing a message that warns an unwelcome caller that the caller is unwelcome.

7. The method of claim 5, wherein the step of playing a noise to the caller comprises playing a tone to the caller.

8. The method of claim 7, wherein the tone continues for [ANY PREDETERMINED TIME WHETHER IT BE 1 SECOND or 45 SECONDS or MORE]

9. The method of claim 5, wherein the step of playing the second message to the caller comprises playing a message that invites a welcome caller to leave a message.

10. A method of screening telephone calls utilizing a system for screening telephone calls that includes a call handler, a processor, in communication with the call handler, and a memory unit, in communication with the processor, comprising the steps of:
receiving an incoming call;
setting an integer value to 1;
playing a prerecorded voice message;
playing a prerecorded noise packet;
increasing the integer value by 1; and
checking the integer value and replaying the prerecorded voice message, replaying the prerecorded noise packet, and increasing the integer value by 1 if the integer value is less than 3, and allowing a caller to leave a message if the integer value is greater than or equal to 3.
